(19) United States
(12) Patent Application Publication
(10) Pub. No.: US 2005/0125109 A1
(43) Pub. Date: Jun. 9, 2005

(54) Sensor harness fixing structure

(76) Inventors: Kenji Hayashi, Tokyo (JP); Masayauki Kayano, Tokyo (JP); Yoshio Katayama, Kobe-shi (JP)

Correspondence Address: ROSSI & ASSOCIATES, P.O. BOX 826, ASHBURN, VA, 20146-0826, US

(21) Appl. No.: 10/987,580

(22) Filed: Nov. 12, 2004

(30) Foreign Application Priority Data
Nov. 14, 2003 (JP) 2003-384490

(51) Int. Cl. G06F 1/16

(52) U.S. Cl. 701/1; 361/679; 248/638

(57) ABSTRACT

A sensor harness fixing structure comprises a case having a protrusion on the outer surface thereof, and another case having a notch to be fitted with the protrusion, and disposed outside the case. A curved portion is provided at the bottom of the notch, and another curved portion is provided in a portion of the protrusion opposed to the curved portion. A harness from ultrasonic sensors disposed inside the case is interposed and held between the curved portion and the other curved portion via an elastic material such as rubber. The harness is fixed reliably with high waterproofness.

### CROSS REFERENCE TO RELATED APPLICATION

The entire disclosure of Japanese Patent Application No. 2003-384490 filed on Nov. 14, 2003, including specification, claims, drawings and summary, is incorporated herein by reference in its entirety.

### BACKGROUND OF THE INVENTION

1. Field of the Invention

This invention relates to a fixing structure for a harness for sensors and, more specifically, a harness fixing structure preferred for sensors provided outside a vehicle.

2. Description of the Related Art

In recent years, various control devices have been provided in a vehicle from the viewpoints of safety and operability, and various sensors have been used accordingly. These sensors are disposed in various portions of the vehicle. For example, a small sensor as a single unit may be configured such that the sensor and a harness are held integrally by a member such as resin. Such a configuration can serve as a waterproof structure capable of supporting the harness (Japanese Patent Application Laid-Open No. 2001-343292, pages 3-4, FIGS. 1 to 6). This structure can be provided not only inside the vehicle, but also in an engine portion subjected to high temperatures, and on the exterior of the vehicle exposed to rain, etc.

Among sensors used in control devices, there are those which are used as single units, such as temperature sensors, and those which are used as combinations of transmitters and receivers, such as ultrasonic sensors. With a sensor which uses a plurality of instruments (hereinafter referred to as a sensor unit), it is common practice to hold each of the instruments in a single case, integrate lead wires from the respective instruments into a harness, and perform the supply of power and the outputting of a detected signal with the use of the harness. If the sensor unit is provided outside the vehicle, the influence of the surroundings of the vehicle, i.e., the influence of rain, etc., has to be considered. Unless the use of an appropriate fixing structure for the harness is considered, water may enter the interior of the case via the harness. If the sensor unit is provided below the vehicle, in particular, consideration has to be given to the influence of water splashing up from the road surface.

Furthermore, if the sensor unit is provided outside the vehicle, the sensor, etc. are often stained, and need cleaning at appropriate times. During washing with water or the like, care should be taken to prevent entry of water into the case via the harness.

The present invention has been accomplished in the light of the above-mentioned problems. It is an object of the present invention to provide a sensor harness fixing structure which fixes the harness reliably and has high waterproofing properties.

### SUMMARY OF THE INVENTION

According to a first aspect of the present invention, for solving the above-mentioned problems, there is provided a sensor harness fixing structure, comprising:
a first case accommodating sensors in an interior thereof, and having a protrusion on an outer surface thereof; and
a second case having a notch to be fitted with the protrusion.

An opening of the first case, and an opening of the second case are opposed to each other, and the second case is placed and fitted outside the first case to constitute one case.

A curved portion is provided at the bottom of the notch of the second case, and another curved portion is provided in a portion of the protrusion of the first case which is opposed to the curved portion of the second case.

In fixing a harness for the sensors disposed inside the first case, the harness is interposed and held between the curved portion of the second case and the other curved portion of the first case. Thus, the harness for the sensors is interposed and held on the same plane, and is reliably fixed.

According to a second aspect of the present invention, the harness for the sensors may be interposed and held via an elastic material such as rubber. By covering and clamping the harness for the sensors by use of the elastic material such as rubber, the harness itself can be protected, and the clamped portion ensures tight contact.

According to a third aspect of the present invention, the elastic material may be a corrugated tube covering the harness, the corrugated tube may have projections and depressions formed on the surface thereof, and projections and depressions corresponding to the projections and depressions formed in the corrugated tube may be formed in the first case and the second case.

According to the present invention with the above-described aspects, the harness for the sensors provided outside the vehicle can be reliably fixed, and the entry of water into the sensors via the harness can be prevented.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configuration drawing of a truck equipped with an optical axis adjusting apparatus for a vehicle headlamp;

FIG. 2 is a plan view of a frame of the truck shown in FIG. 1;

FIG. 3 is a configuration drawing showing an embodiment of a sensor harness fixing structure according to the present invention;

FIG. 4 is a view showing the mounting of an incline sensor, as shown in FIG. 3, to a cross member;

FIG. 5 is a sectional view of the incline sensor and the cross member mounted together; and

FIG. 6 is a configuration drawing showing another embodiment of the sensor harness fixing structure according to the present invention.

### DETAILED DESCRIPTION OF THE PREFERRED EMBODIMENTS

Various sensors are provided outside a vehicle. In the present invention, a sensor unit composed of ultrasonic sensors used for adjusting the optical axis of a vehicle headlamp is taken as an example to explain an embodiment of a sensor harness fixing structure according to the present invention.

Embodiment 1:

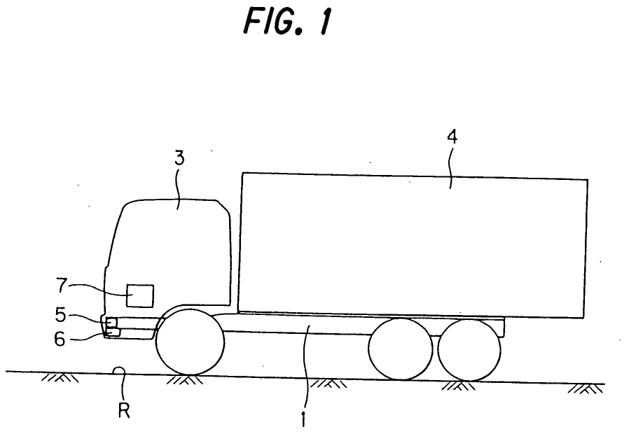

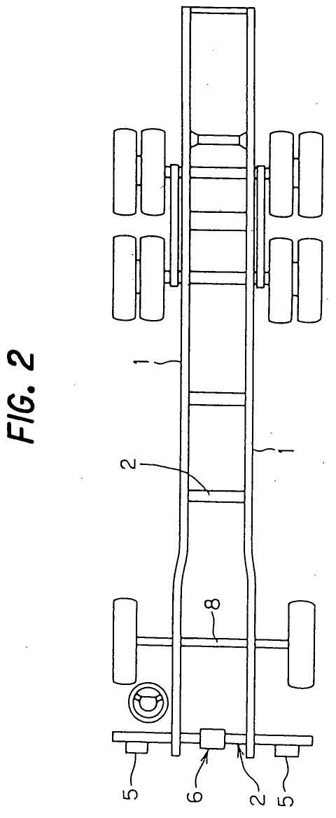

FIG. 1 is a schematic configuration drawing of a truck equipped with an optical axis adjusting apparatus for a vehicle headlamp. FIG. 2 is a plan view of a frame of the truck shown in FIG. 1.

As shown in FIG. 1 and FIG. 2, a truck has a frame mainly composed of a set of (i.e., right and left) side frames 1, and a plurality of cross members 2 assembled perpendicularly to the side frames 1, and has a cab 3 and a cargo bed 4 mounted on this frame. Right and left headlamps 5 are mounted on both sides of the cross member 2 located in a front end portion of the vehicle. An incline sensor 6, which serves as a sensor unit using a plurality of ultrasonic sensors, is disposed at a nearly middle portion of the cross member 2. A detection signal from the incline sensor 6 is inputted into an ECU 7 as a control instrument, and the ECU 7 determines the inclined state of a front portion of the vehicle relative to a road surface R based on the detection signal of the incline sensor 6.

The right and left headlamps 5 may be provided in the cab 3, and the incline sensor 6 may be provided on side rails above a front axle 8, or provided at an end portion of the vehicle which is other than the cross member 2 (for example, on the cab 3).

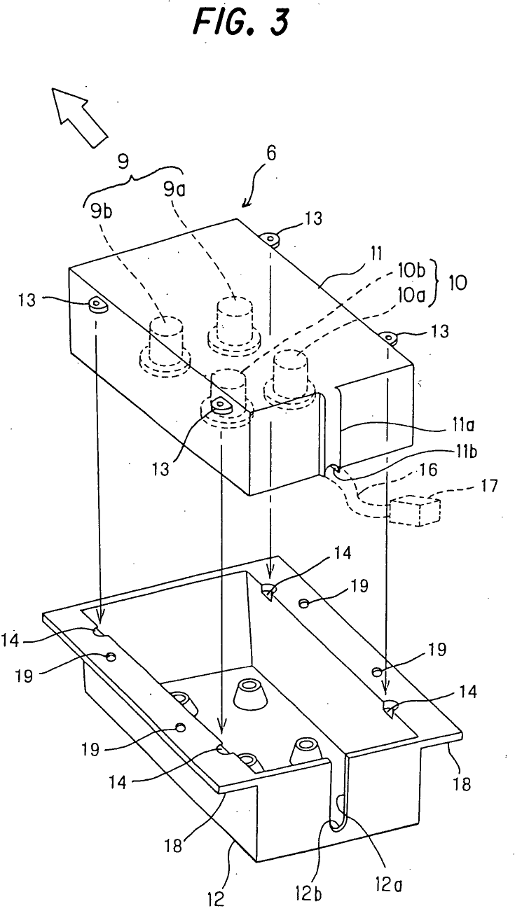

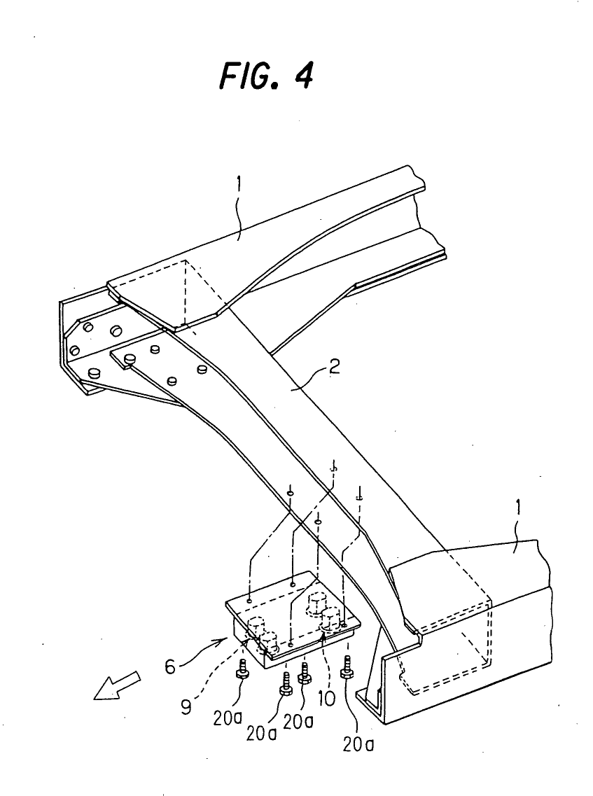

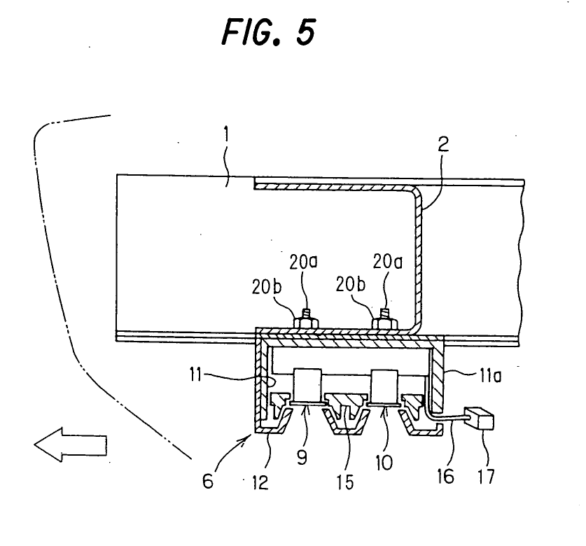

FIG. 3 is a configuration drawing showing an embodiment of a sensor harness fixing structure according to the present invention, and shows the configuration of the incline sensor 6 shown in FIGS. 1 and 2. A view showing the mounting of the incline sensor 6 to the cross member 2, and a sectional view of the incline sensor 6 and the cross member 2 mounted together are offered as FIG. 4 and FIG. 5, respectively.

As shown in FIG. 3, the sensor harness fixing structure according to the present invention is composed of a case 11 (first case) of a U-shaped cross section having a protrusion 11a on the outer surface thereof, and a case 12 (second case) of a nearly U-shaped cross section having a notch 12a to be fitted with the protrusion 11a of the case 11. The opening of the case 11 and the opening of the case 12 are opposed to each other, the case 12 is placed on and fitted to the exterior of the case 11, and screw-holding portions 13 of the case 11 are tightened against screw-receiving portions 14 of the case 12 by means of screws. By this procedure, one box-shaped case, which becomes a housing of the incline sensor 6, is formed.

Inside the case 11, ultrasonic sensors 9 and 10 are disposed. A cover 15, which has openings in portions corresponding to transmitting and receiving surfaces of the ultrasonic sensors 9 and 10, is provided on the transmitting and receiving surface side (the side where the case 12 is located) of the ultrasonic sensors 9 and 10 to form a sensor body portion. A curved portion 12b is provided at the bottom of the notch 12a of the case 12. Another curved portion 11b is provided in a portion of the protrusion 11a of the case 11 which is opposed to the curved portion 12b of the case 12. A harness 16 composed of lead wires of the ultrasonic sensors 9 and 10 is led out of the cases 11 and 12 through a gap formed by the curved portions 11b and 12b, and is connected to the ECU 7 via a connector 17 to enter detected signals into the ECU 7.

That is, the incline sensor 6 holds the ultrasonic sensors 9 and 10 inside the case 11 having the above-described structure, and interposes and holds the harness 16 from the ultrasonic sensors 9 and 10 between the curved portion 11b of the case 11 and the curved portion 12b of the case 12, thereby keeping the harness 16 in a clamped state on the same plane, reliably fixing it, and ensuring intimate contact, leading to enhanced waterproofness.

Moreover, the harness 16 is kept clamped and held via an elastic material such as rubber and, concretely, the harness 16 is wrapped in a covering material, such as a rubber tube. By this measure, the harness 16 itself can be protected from a force exerted by the case 11 and the case 12, and the clamped portion can be brought into more intimate contact to enhance waterproofness further. As the covering material, not only the rubber tube, but also a resin tube, PVC (polyvinyl chloride) tube, or a corrugated tube may be used.

In the incline sensor 6, the transmitting and receiving surfaces of the ultrasonic sensors 9 and 10 need to be exposed to the road surface so that the ultrasonic sensors 9 and 10 can detect the road condition. For this purpose, the portions of the case 12, where the transmitting and receiving surfaces of the ultrasonic sensors 9 and 10 are located, are opened to be capable of transmitting and receiving ultrasonic signals. These opening portions are also configured such that the sensor surfaces are positioned inwardly of the case 12, so that foreign matter, water or the like will not penetrate inside through the opening portions.

The incline sensor 6, as shown in FIG. 4, is attached to an intermediate portion of the cross member 2 by means of bolts 20a and nuts 20b through bolt holes 19 provided in a peripheral edge portion 18 of the case 12, whereby the incline sensor 6 is attached to the front portion of the vehicle so as to be opposed to the road surface R. Moreover, the ultrasonic sensors 9 and 10 are housed in the cases 11 and 12, whereby the incline sensor 6 itself can be rendered compact, and can be easily mounted onto the cross member 2.

The configuration and actions of the ultrasonic sensors 9 and 10 constituting the incline sensor will be explained briefly. The two ultrasonic sensors 9 and 10 are composed of transmitters 9a and 10a as signal transmitting portions, and receivers 9b and 10b as signal receiving portions, for transmitting and receiving ultrasonic signals in the vehicle width direction of the vehicle. In detail, the transmitters 9a and 10a are disposed on one side (for example, right side) in the vehicle width direction, while the receivers 9b and 10b are disposed on the other side (for example, left side) in the vehicle width direction. The directions of ultrasonic waves transmitted and received by the ultrasonic sensors 9 and 10 are nearly parallel to each other, and are nearly perpendicular to the longitudinal direction of the vehicle.

The incline sensor 6 determines the inclined state of the vehicle relative to the road surface R based on a difference in receiving time between the ultrasonic waves transmitted and received by the two ultrasonic sensors 9 and 10. Concretely, assume that when the ultrasonic signals from the transmitters 9a and 10 are reflected by the road surface R and received by the receivers 9b and 10b, the front portion of the vehicle is inclined with respect to the road surface R. In this case, the heights at which the ultrasonic sensors 9 and 10 detect the ultrasonic signals are different. Thus, a difference occurs between the length of the path of the ultrasonic signal transmitted from the transmitter 9a to the receiver 9b and the length of the path of the ultrasonic signal transmitted from the transmitter 10a to the receiver 10b. As a result, a receiving time difference arises between the receivers 9b and 10b. Based on this receiving time difference between the receivers 9b and 10b, the inclined state of the vehicle relative to the road surface R is determined by the ECU 7.

Embodiment 2:

As another embodiment of the sensor harness fixing structure according to the present invention, an explanation will be offered for a structure in which the harness is covered with a corrugated tube.

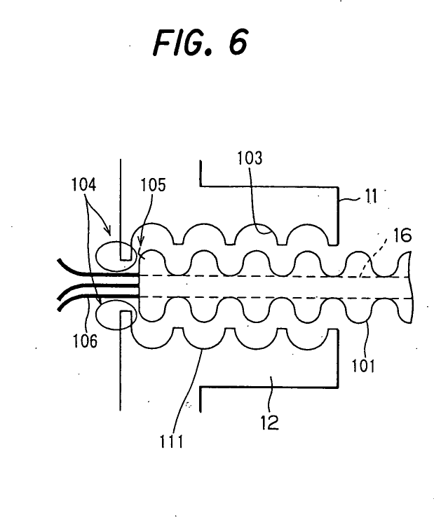

As shown in FIG. 6, a harness 16 is covered with a corrugated tube 101 (elastic material) of a surface shape having projections and depressions, thereby making it possible to lower the possibility that the harness 16 and the corrugated tube 101 as the covering material will be damaged by a case 11 (first case) and a case 12 (second case). The projections and depressions on the surface of the corrugated tube 101 can also prevent the penetration of water more reliably.

Moreover, a surface 103 of the case 11 and a surface 111 of the case 12, both surfaces opposed to the corrugated tube 101, have a corrugated shape (projections and depressions) extending along the shape of the corrugated tube 101, thereby forming a labyrinthine structure between the corrugated tube 101 and the surfaces 103, 111, so that the penetration of water can be prevented more reliably.

Furthermore, a burr 105 may be produced on the end face (cut surface) of the corrugated tube 101. In order that core wires 106 will not be damaged by the burr 105, protective plates 104 are protruded from the cases 11 and 12 to keep the burr 105 and the core wires 106 out of contact with each other.

Besides, the harness 16 may be covered with a covering material such as a rubber tube, and further covered with the corrugated tube 101.

While the present invention has been described by the foregoing embodiments, it is to be understood that the invention is not limited thereby, but may be varied in many other ways. For example, the ultrasonic sensor has been taken as an example for the purpose of explanation. However, the present invention is not limited to the ultrasonic sensor, but can be applied to various other sensors, such as a laser sensor, and a height sensor. Such variations are not to be regarded as a departure from the spirit and scope of the invention, and all such modifications as would be obvious to one skilled in the art are intended to be included within the scope of the appended claims.

1. A sensor harness fixing structure, comprising:
a first case accommodating sensors in an interior thereof, and having a protrusion on an outer surface thereof; and
a second case having a notch to be fitted with said protrusion, and disposed outside said first case, and wherein
a curved portion is provided at a bottom of said notch,
other curved portion is provided in a portion of said protrusion opposed to said curved portion, and
a harness for said sensors is interposed and held between said curved portion and said other curved portion.

2. The sensor harness fixing structure according to claim 1, wherein
said harness is interposed and held via an elastic material.

3. The sensor harness fixing structure according to claim 2, wherein
said elastic material is a corrugated tube covering said harness,
said corrugated tube has projections and depressions formed on a surface thereof, and
projections and depressions corresponding to said projections and depressions are formed in said first case and said second case.
